(19) United States
(12) Patent Application Publication
(10) Pub. No.: US 2013/0041827 A1
(43) Pub. Date: Feb. 14, 2013

(54) Automated Inventory and Return Letter Process

(71) Applicants: Theresa Brennan, Garnet Valley, PA (US); Sarah C. D'Auito, Smyrna, DE (US)

(72) Inventors: Theresa Brennan, Garnet Valley, PA (US); Sarah C. D'Auito, Smyrna, DE (US)

(73) Assignee: Bank of America Corporation, Charlotte, NC (US)

(21) Appl. No.: 13/205,855

(22) Filed: Aug. 9, 2011

(51) Int. Cl. G06Q 40/00

(52) U.S. Cl. 705/45

(57) ABSTRACT

In an exemplary embodiment, a system includes an intake module, the intake module operable to process a plurality of payment instruments. The system includes a memory operable to store an image file associated with one of the payment instruments, the payment instrument associated with a payment account, and store a plurality of flagged account records. The system also includes a processor operable to determine if at least one flagged account record exists that is associated with the payment account and create a payment exception record if a flagged account record exists that is associated with the payment account. The processor is also operable to determine a status of the payment exception record, associate the status of the payment exception record with the image file, and designate a physical destination of the payment instrument, wherein the physical destination is designated based on the status of the payment exception record.

### TECHNICAL FIELD OF THE INVENTION

This invention relates generally to managing the inventory of customer payments and, more specifically, to an automated inventory and return letter process.

### BACKGROUND OF THE INVENTION

Financial institutions must deal with a large number of customer payments, such as checks, on a daily basis. Processing a large number of customer payments can be complicated and prone to error. When processing a large number of customer payments, sometimes the payments can be misplaced. Other times, it might be difficult to communicate the status of the payment to the customer. Currently, processing a large number of customer payments requires substantial handling and processing by employees of the financial institutions. Prior attempts to correct the problems associated with processing customer payments have failed.

### SUMMARY OF THE INVENTION

According to embodiments of the present disclosure, disadvantages and problems associated with previous systems processing payment instruments may be reduced or eliminated.

In certain embodiments, a system includes an intake module, a memory, a processor, and a sorting device. The intake module is operable to process a plurality of payment instruments. The memory is operable to store an image file associated with a particular one of the plurality of payment instruments, the particular one of the plurality of payment instruments associated with a payment account. The memory is also operable to store a plurality of flagged account records, wherein each one of the flagged account records comprises a flagged account identifier for a flagged account. The processor is coupled to the memory and is operable to determine if at least one flagged account record exists that is associated with the payment account and create a payment exception record if at least one flagged account record exists that is associated with the payment account, wherein the payment exception record is associated with the payment account. The processor is also operable to determine a status of the payment exception record, associate the status of the payment exception record with the image file, and designate a physical destination of the particular one of the plurality of payment instruments, wherein the physical destination is designated based on the status of the payment exception record. The sorting device is operable to physically direct the particular one of the plurality of payment instruments to the designated destination.

Particular embodiments of the present disclosure may provide one or more technical advantages. For example, the present disclosure allows for the easier handling of payments such as checks. An enterprise, such as a financial institution, can more efficiently track where checks it has received are located. The financial institution can also more efficiently determine the proper procedure to apply to the check. Another advantage of the present disclosure is that it lessens the burden of processing payments, such as checks, for the agents of the financial institution. Prior methods for handling a high volume of payments were complicated and prone to error requiring a high number of steps to be executed by agents of the financial institution. The present disclosure allows for the efficient intake and processing for a high number of payments while minimizing the manual labor of the agents. Furthermore, the present disclosure allows for associating processed payments with letters notifying a customer of the status of their payment. This increases the ability of financial institutions to ensure that the processed payment will be returned to the proper customer along with communication from the financial institution explaining the current status of the customer's payment.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawing, in which:

FIG. 1 illustrates an exceptions payment workflow system that processes customer payments that are issued from an account from which payments may be made.

### DETAILED DESCRIPTION OF THE INVENTION

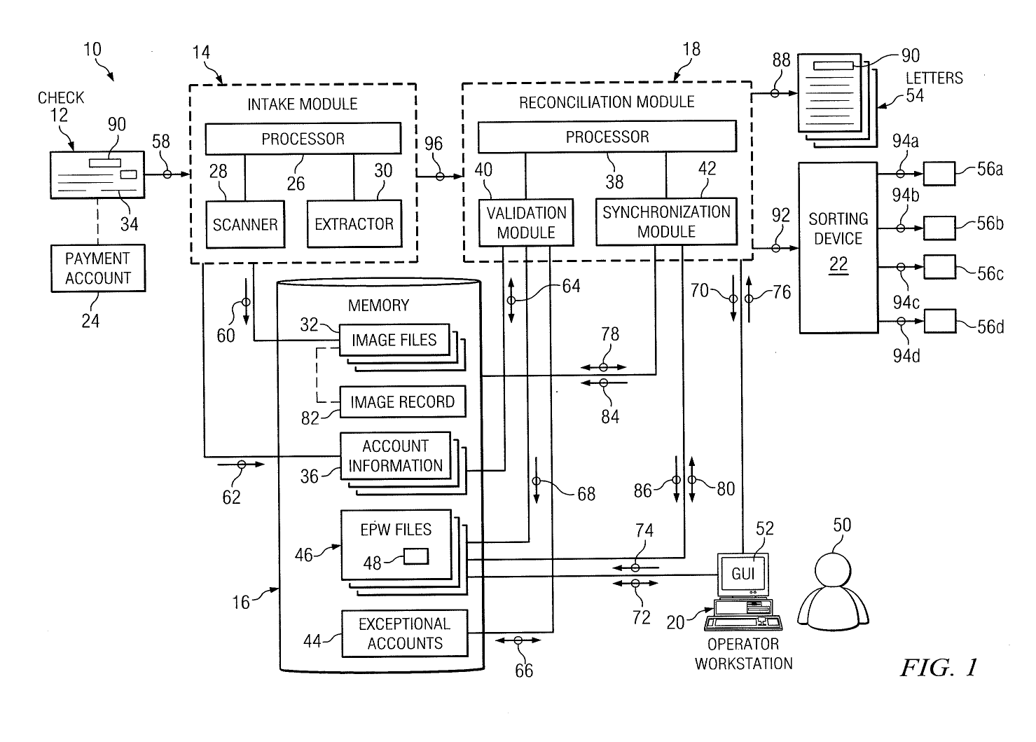

FIG. 1 illustrates an exceptions payment workflow (“EPW”) system 10, according to certain embodiments. In general, EPW system 10 is used by enterprises, such as financial institutions, to process customer payments that are issued from an account from which payments may be made. For example, these payments may be made in the form of a personal check. In some instances, the payment may be rejected for a variety of reasons. If the payment is rejected, a financial institution may want to return the payment to the customer. EPW system 10 is able to handle these rejected payments by imaging and extracting information from the check and then determining whether the check was issued from an account from which payments are to be rejected. Once the customer payment is rejected, EPW system 10 is able to ready the payment to be returned to the customer by printing a unique identification number on the payment and sorting it to an appropriate collection bin. EPW system 10 is also able to create a rejection letter to be mailed with the rejected payment to the customer. The rejection letter also has the unique identification number printed on it. An agent of the financial institution is able to match the rejected payment with the rejection letter based on the unique identification number. The customer is then notified via mail and the payment is returned. EPW system 10 comprises intake module 14, memory 16, reconciliation module 18, operator workstation 20, and sorting module 22.

EPW system 10 receives a plurality of payment instruments 12 to process. Payment instrument 12 represents a payment from payment account 24. For example, payment instrument 12 may be a personal check, a cashier's check, a certified check, or any other payment instrument type capable of representing a payment from payment account 24, and received by EPW system 10. Payment instrument 12 may be issued directly from the owner of payment account 24, by a financial institution on the behalf of the owner of payment account 24, or any other agent on the behalf of the owner of payment account 24. Payment instrument 12 contains textual component 34. Textual component 34 of payment instrument 12 may contain information that can be used to identify payment account 24. Additionally, textual component 34 may be information pertaining to the monetary value of payment instrument 12. In certain embodiments, textual component 34 may be encoded in a magnetic ink character recognition (“MICR”) format.

EPW system 10 receives payment instruments 12 at intake module 14. In general, intake module 14 is responsible for scanning the payments and extracting various pieces of information from the payments. More specifically, intake module 14 represents any suitable components that facilitate the intake of payment instrument 12. Intake module 14 is capable of facilitating the intake of a plurality of payment instruments 12; however, for illustrative purposes only, a single payment instrument 12 is depicted. Intake module 14 may include processor 26, image scanner 28, and extractor 30. Processor 26 communicatively couples to image scanner 28, extractor 30, and memory 16. Processor 26 includes any hardware and/or software that operates to control and process information. For example, processor 26 may execute software to control the operation of intake module 14. Processor 26 may be a programmable logic device, a microcontroller, a microprocessor, any suitable processing device, or any suitable combination of the preceding. For example, in certain embodiments, intake module 14 is comprised of an OPEX Eagle and/or an OPEX 3690.

Image scanner 28 represents any suitable component that facilitates the optical scanning and image capture of payment instrument 12. The resulting captured image of payment instrument 12 can be transferred to memory 16 and stored as digital image file 32. Digital image file 32 may be of any suitable digital format that contains the digital image of payment instrument 12. For example, digital image file 32 may be stored as Bitmap, TIFF, PNG, JPEG, GIF, PDF, or any other suitable digital format. Digital image file 32 may be encoded in any suitable digital format by intake module 14, processor 26, image scanner 28, or any other component of EPW system 10 capable of encoding raw image data into a suitable digital format. Additionally, intake module 14 may also facilitate the creation of image file record 82 stored in memory 16. Image file record 82 contains information pertaining to digital image file 32. For example, in certain embodiments, image file record 82 may be contained in a table of image file records stored in memory 16.

Generally, extractor 30 is responsible for detecting the content of payment instrument 12. Extractor 30 represents any suitable component that facilitates the translation of payment instrument 12 into an electronic text format. For example, extractor 30 may be capable of using hardware and/or software to conduct optical character recognition to detect textual component 34 of payment instrument 12. The detected textual component 34 of payment instrument 12 can be converted into electronic data and be transferred to memory 16 and stored in a digital format as account information record 36. The digital format of account information record 36 may be a text file, a Microsoft Word document, a PDF file, an entry into a table in a database or any other suitable digital format for storing text.

Memory 16 stores, either permanently or temporarily, data, operational software, or other information for processors 26 and 38 and operator workstation 20. Memory 16 includes any one or a combination of volatile or non-volatile local or remote devices suitable for storing information. For example, memory 16 may include random access memory (RAM), read only memory (ROM), magnetic storage devices, optical storage devices, or any other suitable information storage device or a combination of these devices. While illustrated as including particular files, modules, or information, memory 16 may include any suitable information for use in the operation of EPW system 10.

Reconciliation module 18 is responsible for determining how payment instrument 12 should be processed. Reconciliation module 18 represents any suitable components that facilitate the analysis, comparison, decision-making, synchronization, or any other interaction with payment instrument 12, account information record 36, image file 32, exceptional accounts file 44, operator workstation 20, sorting module 22, or any other component of EPW system 10. Reconciliation module 18 may include processor 38, validation module 40, and synchronization module 42. Processor 38 communicatively couples to validation module 40, synchronization module 42, memory 16, operator workstation 20, and sorting module 22. Processor 38 includes any hardware and/or software that operates to control and process information. For example, processor 38 may execute software to control the operation of reconciliation module 18. Processor 38 may be a programmable logic device, a microcontroller, a microprocessor, any suitable processing device, or any suitable combination of the preceding. Although depicted separately and individually in FIG. 1 for illustrative purposes, the functionality and capabilities of processors 26 and 38 may be included in a single processor.

In general, validation module 40 is responsible for determining whether payment instrument 12 was issued from an account from which payments may be rejected. Flagged accounts from which payments are to be rejected reside in a central location, such as a file. Validation module 40 compares payment instrument 12 with the accounts in the file. If validation module determines payment instrument 12 was issued from a flagged account, then validation module 40 creates and prepares an EPW file for further processing. More specifically, validation module 40 represents any combination of hardware, software, and controlling logic to validate account information record 36. For example, validation module 40 may validate account information record 36 by comparing account information record 36 with flagged account records contained in exceptional accounts file 44. Certain payment accounts may have been flagged such that certain payments may be rejected and returned by EPW system 10. In certain embodiments, such flagged payment accounts are stored as flagged account records in exceptional accounts file 44. Exceptional accounts file 44 may be a text file, a Microsoft Word document, a PDF file, an entry in a table in a database or any other suitable digital format for storing data in memory 16. If account information record 36 is contained in exceptional accounts file 44, validation module 40 is able to create and store EPW file 46 in memory 16.

Generally, EPW file 46 contains information related to the processing of payment instrument 12. Specifically, EPW file 46 may be a text file, a Microsoft Word document, a PDF file, an entry in a table in a database or any other suitable digital format for storing data in memory 16. In certain embodiments, EPW file 46 may contain information pertaining to payment instrument 12, payment account 24, textual component 34, the monetary value of payment instrument 12, and/or account information record 36. Additionally, EPW file 46 may contain information pertaining to status 48. After the creation of EPW file 46, operator 50 may make a business decision regarding payment instrument 12. Operator 50 can decide how the financial institution should proceed with processing payment instrument 12. This decision may be represented by status 48. Status 48 is determined by operator 20 from a plurality of potential statuses. Status 48 represents a decision a financial institution may make when processing EPW file 46. Status 48 may provide instruction for what needs to be done next for EPW file 46, payment instrument 12, or any other file or data associated with payment account 24. For example, status 48 might be set to one of the following: “return,” “delete,” “apply,” “mismatch,” or “pending.” An example of when status 48 may be set to “return” is when operator 50 has decided that payment instrument 12 must be rejected and returned to the customer. Setting status 48 to “delete” may be appropriate when the financial institution does not accept payment instrument 12 and thus payment instrument 12 needs to be deleted from EPW system 10. It may be appropriate to set status 48 to “apply” when operator 50 has decided that the financial institution will accept payment instrument 12 for payment. An example for when status 48 may be set to “mismatch” is if operator 50 has determined that image file 32 is not an accurate representation of payment instrument 12. For example, image file 32 may be an upside down representation of payment instrument 12 or may have captured the wrong side of payment instrument 12. Operator 50 may set status 48 to “pending” if it is determined that further decisioning is required at a later time for EPW file 48. These are all examples of business decisions operator 50 may make regarding payment instrument 12. Other types of status 48 may also exist within the scope of EPW system 10 and are contemplated to be within the scope of the present disclosure.

Operator 50 may access EPW file 46 and/or reconciliation module 18 through operator workstation 20. Operator 50 may include any individual, group of individuals, entity, machine, and/or mechanism that interacts with operator workstation 20. Examples of operator 50 include, but are not limited to a manager, an executive, a review board, an accountant, an agent, an engineer, a technician, a contractor, and/or an employee.

Generally, operator 50 can access operator workstation 20 to implement various business decisions regarding payment instrument 12 and/or EPW file 46. More specifically, operator workstation 20 represents any suitable local or remote end-user device that may be used by operator 50 to access one or more elements of EPW system 10. Operator workstation 20 may comprise a computer, workstation, telephone, internet browser, electronic notebook, Personal Digital Assistant (PDA), pager, or any other suitable device (wireless, wireline, or otherwise), component, or element capable of receiving, processing, storing, and/or communicating information with other components of EPW system 10. It will be understood that EPW system 10 may comprise any number and combination of operator workstations 20. In some embodiments, operator workstation 20 may comprise a graphical user interface (GUI) 52. GUI 52 is generally operable to tailor and filter data presented to a user. GUI 52 may provide a user with an efficient and user-friendly presentation of information regarding the various components of EPW system 10. GUI 52 may comprise a plurality of displays having interactive fields, pull-down lists, and buttons operated by operator 50. GUI 52 may include multiple levels of abstraction including groups and boundaries.

In general, synchronization module 42 is responsible for ensuring that information such as status 48 is synchronized between image file 32, image record 82, and EPW file 46. More specifically, synchronization module 42 represents any combination of hardware, software, and controlling logic to facilitate the association of status 48 with image file 32 in memory 16. In certain embodiments, synchronization module 42 may determine EPW file 46 contains status 48 that is not currently associated with image file 32. If synchronization module 42 determines that status 48 is not associated with image file 32, synchronization module 42 is capable of then associating status 48 with image file 32. Synchronization module 42 is capable of determining errors with EPW file 46 and/or image file 32. For example, synchronization module 42 may determine that image file 32 is in an incorrect format for processing according to status 48 of EPW file 46. Synchronization module 42 is capable of then facilitating corrective measures to image file 32 which will bring image file 46 in accordance with status 48. Synchronization module 18 is also capable of communicating with operator workstation 20, or any other component of EPW system 10, providing feedback pertaining to the various actions undertaken by synchronization module 18. For example, synchronization module 18 may provide a message to operator workstation 20 notifying operator 50 of progress made by synchronization module 18. Additionally, synchronization module 42 can associate destination 56 with payment instrument 12. For example, synchronization module 42 may update a field in EPW file 46 designating which particular destination 56 payment instrument 12 will be physically directed to by sorting module 22.

While processing payment instrument 12, it may be necessary to generate written communication, such as a letter, intended for a customer regarding the current status of payment instrument 12. In certain embodiments, reconciliation module 18 is capable of facilitating the generation of written communication 54. Written communication 54 contains communication pertaining to payment instrument 12 and payment account 24. For example, written communication 54 may provide information corresponding to status 48, EPW file 46, payment instrument 12, and/or payment account 24. Written communication 54 may be a text file, electronic mail, a letter, or any other suitable communication format capable of containing information pertaining to status 48, EPW file 46, payment instrument 12, and/or payment account 24. Additionally, written communication 54 may include unique identifier 90. Unique identifier 90 associates written communication 54 with payment instrument 12.

Sorting module 22 is responsible for moving payment instrument 12 into an appropriate container before an agent of the financial institution readies payment instrument 12 to be sent back to a customer pending a decision or when submitted for clearing. Sorting module 22 represents any combination of hardware, software, and controlling logic to facilitate the physical directing of payment instrument 12 to destination 56. Destination 56 may be one of a plurality of destinations to which payment instrument 12 can be directed. Payment instrument 12 may be designated to destination 56 in EPW file 46. For example, in certain embodiments, destination 56a may be for payment instrument 12 where status 48 in EPW file 46 is set to “return.” Destination 56b may be designated for payment instrument 12 if status 48 is set to “apply.” Destination 56c may be designated for payment instrument 12 if status 48 is set to “delete.” Destination 56d may be designated for payment instrument 12 if status 48 is set to “pending.” Destination 56 may be a bin or container capable of holding payment instrument 12. Sorting module 22 is capable of physically directing payment instrument 12 to destination 56. For example, in certain embodiments, sorting module 22 may be comprised of an NCR iTRAN transporter.

Generally, the operation of EPW system 10 begins when EPW system 10 receives payment instrument 12. In an exemplary embodiment of operation, intake module 14 may receive request 58 to intake payment instrument 12. Intake module 14 facilitates communication between processor 26 and image scanner 28 to initiate the optical scanning and image capture of payment instrument 12. Intake module 14 communicates message 60 to memory 16, requesting to store the captured image data as digital image file 32 and information pertaining to image file 32 as image file record 82. Message 60 comprises the captured image data and information pertaining to image file 32. Intake module 14 facilitates communication between processor 26 and extractor 30 to translate textual component 34 of payment instrument 12 into an electronic text format. For example, intake module 14 may facilitate extractor 30 to conduct optical character recognition to detect textual component 34 of payment instrument 12 and to translate textual component 34 into electronic data. Intake module 14 communicates message 62 to memory 16. Message 62 comprises the electronic data of textual component 34 and a request to store the electronic data in a digital format as account information record 36. Intake module 14 may send notification 96 to reconciliation module 18 after completion of the intake procedure of payment instrument 12.

Reconciliation module 18 next determines how payment instrument 12 should be processed. Specifically, reconciliation module 18 may facilitate the reconciliation process based on a pre-scheduled time, in response to notification 96, or in response to any other instruction by EPW system 10. For example, reconciliation module 18 may be scheduled to conduct the reconciliation process on all account information records 36 on a daily basis at a particular time. Although reconciliation module 18 is capable of facilitating the reconciliation process on a plurality of account information records 36, for illustrative purposes only, the process will be described for a single account information record 36. Reconciliation module 18 may facilitate communication between processor 38 and validation module 40 to communicate request 64 to memory 16 to retrieve account information record 36.

Payment instrument 12 may have been issued from an account from which payments may be rejected. Flagged accounts from which payments are to be rejected reside in a central location, such as a file. Validation module 40 compares payment instrument 12 with the flagged accounts in the file. If validation module determines payment instrument 12 was issued from a flagged account, then validation module 40 creates and prepares an EPW file for further processing. For example, reconciliation module 18 may facilitate communication between processor 38 and validation module 40 to communicate message 66 to memory 16, message 66 comprising a request to retrieve exceptional accounts file 44. In response to message 66, exceptional accounts file 44 is accessed by validation module 42. Validation module 40 facilitates the comparison of account information record 36 with the flagged account records of exceptional accounts file 44. If validation module 40 determines account information record 36 corresponds to a flagged account records in exceptional accounts file 44, then validation module can facilitate the creation of EPW file 46 and communicate message 68 to memory 16, message 68 comprising data and a request to store the data as EPW file 46.

At this point, operator 50 can make a business decision regarding payment instrument 12. Once operator 50 determines how to process payment instrument, operator 50 can record that decision by setting status 48 in EPW file 46. For example, in certain embodiments, reconciliation module 18 may communicate notification 70 to operator workstation 20 to provide notification to operator 50 that a plurality of EPW files 46 are ready for the review of operator 50. Operator 50 may use operator workstation 20 to communicate message 72 to memory 16, message 72 comprising a request to access EPW file 46. In response to message 72, EPW file 46 is accessible to operator 50. Operator 50 may then use GUI 52 of operator workstation 20 to access a particular one of EPW files 46. Operator 50 reviews the content of EPW file 46 and determines a particular status 48 to associate with EPW file 46. In certain embodiments, status 48 might be chosen from a plurality of statuses presented to operator 50 in GUI 52. Once operator 50 has decided to associate status 48 with EPW file 46, operator 50 can facilitate the communication of message 74 to memory 16, message 74 comprising status 48 and a request to associate status 48 with EPW file 46. For example, in certain embodiments, status 48 may be a field in a table containing information pertaining to EPW 46 stored in memory 16. In such embodiments, request 74 may update the field for status 48 based on the decision of operator 50. Once status 48 is associated with EPW file 46, operator 50 may facilitate operator workstation 20 to communicate notification 76 to reconciliation module 18 that EPW file 46 has been updated. In certain embodiments, notification 76 may only be communicated to reconciliation module 18 after a plurality of EPW files 46 have been updated.

Once operator 50 has updated status 48, it may be necessary to synchronize EPW file 46 with image file 32. For example, in certain embodiments, notification 76 is communicated to reconciliation module 18, reconciliation module 18 may continue the reconciliation process by facilitating communication between processor 38 and synchronization module 42 to communicate message 78 to memory 16, message 78 comprises a request to retrieve digital image file 32 and/or image file record 82. In response to message 78, reconciliation module 18 can access digital image file 32 and/or image file record 82. Reconciliation module 18 may continue the reconciliation process by also facilitating communication between processor 38 and synchronization module 42 to communicate message 80 to memory 16, message 80 comprising a request to retrieve EPW file 46. In response to message 80, synchronization module 42 can access EPW file 46. Synchronization module 42 may facilitate a comparison between image file record 82 and EPW file 46. The comparison may include determining whether status 48 of EPW file 46 is associated with image file record 82. If synchronization module determines that status 48 is not associated with image file record 82, synchronization module may communicate message 84 to memory 16, message 84 comprising status 48 and a request to associate status 48 with image file record 82 in memory 16. Additionally, synchronization module 42 may have detected errors associated with image file 32 and may also communicate request 84 to facilitate error correction of image file 32. Synchronization module 42 may determine destination 56 for payment instrument 12 based, in part, on status 48 of EPW file 46. Once destination 56 is determined by synchronization module 42, synchronization module 42 may communicate message 86 to memory 16. Message 86 comprises a request to associate destination 56 with EPW file 46 and payment instrument 12.

In some instances, it may be necessary to send a letter to a customer notifying the customer of the current status regarding the processing of the customer's payment. EPW system 10 is capable of generating the letter intended for the customer. It may also be necessary for agents of the financial institution to be able to match payment instrument 12 to the letter, so that payment instrument 12 can be mailed to the customer along with the letter. EPW system 10 can provide a unique identifier that allows employees to match payment instrument 12 with the generated letter. For example, in certain embodiments, reconciliation module 42 may facilitate the generation of written communication 54 by communicating message 88. Message 88 may contain information corresponding to status 48, EPW file 46, payment instrument 12, and/or payment account 24. Message 88 may comprise the generated written communication 54 or, alternatively, may instruct any component of EPW system 10 to generate written communication 54. Additionally, message 88 may also contain unique identifier 90. Unique identifier 90 associates written communication 54 with payment instrument 12. Unique identifier 90 may be printed onto payment instrument 12 and included in the text of written communication 54 by any component of EPW system 10 that is capable of printing, such as a laser printer, ink jet printer, or copy machine. Furthermore, in certain embodiments, written communication 54 may be stored in memory 16 to be printed at a later time.

After reconciliation module 18 has processed payment instrument 12, it may be necessary for payment instrument 12 to be physically sorted into an appropriate bin where an agent of the financial institution may further handle payment instrument 12. More specifically, once reconciliation module 18 determines payment instrument 12 is ready for physical sorting, reconciliation module 18 communicates message 92 to sorting module 22. Message 92 comprises information pertaining to destination 56. Once message 92 is received by sorting module 22, sorting module 22 physically directs payment instrument 12 to destination 56 via path 94. For example, operator 50 may have set status 48 to “return” for EPW file 46 associated with payment instrument 12. In this example, all payment instruments 12 associated with status 48 of “return” may be collected at destination 56a. Thus, sorting module 22 would facilitate the physical relocation of payment instrument 12 to destination 56a via path 94a. If status 48 is set to “apply,” then sorting module 22 might facilitate the physical relocation of payment instrument 12 to destination 56b via path 94b. If status 48 is set to “delete,” then sorting module 22 might facilitate the physical relocation of payment instrument 12 to destination 56c via path 94c. If status 48 is set to “pending,” then sorting module 22 might facilitate the physical relocation of payment instrument 12 to destination 56d via path 94d. At this point, if necessary, payment instrument 12 may be physically paired with written communication 54 using unique identifier 90. For example, an agent of the financial institution may match payment instrument 12 with written communication 54 based on unique identifier 90 which may be printed on both payment instrument 12 and written communication 54. The agent may then mail both items to the customer that originally issued payment 12 notifying the customer that their payment was rejected.

Although single components may be described in EPW system 10, EPW system 10 is capable of including a plurality of components. For example, EPW system 10 is capable of processing a plurality of payment instruments 12 associated with a plurality of payment accounts 24. Memory 16 is capable of storing a plurality of digital image files 32, image file records 82, EPW files 46, exceptional accounts files 44, and written communications 54. EPW system 10 may contain a plurality of intake modules 14, memories 16, reconciliation modules 18, sorting modules 22, and operator workstations 20. Modifications, additions, or omissions may be made to EPW system 10 without departing from the scope of the invention.

Any component of EPW system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic. Any suitable logic may perform the functions of EPW system 10.

According to the teachings of the present disclosure, one or more technical advantages may be realized. A technical advantage of one embodiment includes efficiently executing an exceptions payment workflow for payments which may be rejected by a financial institution for a variety of reasons. Components within the EPW system may be leveraged automatically to execute various steps of the exceptions payment workflow. Therefore, the need for user intervention is reduced because the exceptions payment workflow may be handled by the various components of the EPW system.

Although the present invention has been described with several embodiments, a myriad of changes, variations, alterations, transformations, and modifications may be suggested to one skilled in the art, and it is intended that the present invention encompasses such changes, variations, alterations, transformations, and modifications as falling within the scope of the appended claims.

What is claimed is:

1. A payment workflow system, comprising:
an intake module operable to process a plurality of payment instruments;
a memory operable to:
store an image file associated with a particular one of the plurality of payment instruments, the particular one of the plurality of payment instruments associated with a payment account; and
store a plurality of flagged account records, wherein each one of the flagged account records comprises a flagged account identifier for a flagged account;
a processor coupled to the memory and operable to:
determine if at least one flagged account record exists that is associated with the payment account;
create a payment exception record if at least one flagged account record exists that is associated with the payment account, wherein the payment exception record is associated with the payment account;
determine a status of the payment exception record;
associate the status of the payment exception record with the image file; and
designate a physical destination of the particular one of the plurality of payment instruments, wherein the physical destination is designated based on the status of the payment exception record; and
a sorting device operable to physically direct the particular one of the plurality of payment instruments to the designated destination.

2. The system of claim 1, wherein the processor is further operable to generate a written communication, the generated written communication based on at least the status of the payment exception record.

3. The system of claim 2, wherein the processor is further operable to:
assign a unique identifier to the particular one of the plurality of payment instruments, the unique identifier associated with the generated written communication; and
initiate the printing of the unique identifier onto the particular one of the plurality of payment instruments.

4. The system of claim 1, wherein processing the plurality of payment instruments comprises:
generating the image file by scanning the particular one of the plurality of payment instruments; and
extracting payment information from the particular one of the plurality of payment instruments.

5. The system of claim 4, wherein the extracted payment information comprises the identifier for the account.

6. The system of claim 4, wherein the extracted payment information comprises the monetary value of the particular one of the plurality of payment instruments.

7. The system of claim 4, wherein the payment information is encoded in a magnetic ink character recognition format.

8. The system of claim 1, wherein the particular one of the plurality of payment instruments is a selected one of a group of payment instrument types, the group consisting of:
a) personal check;
b) certified check; and
c) cashier's check.

9. The system of claim 1, wherein associating the status of the payment exception record with the image file comprises updating an image file with information from a corresponding payment exception record for a given payment account.

10. A method, comprising:
processing a plurality of payment instruments;
storing an image file associated with a particular one of the plurality of payment instruments, the particular one of the plurality of payment instruments associated with a payment account;
storing a plurality of flagged account records, wherein each one of the flagged account records comprises a flagged account identifier for a flagged account;
determining if at least one flagged account record exists that is associated with the payment account;
creating a payment exception record if at least one flagged account record exists that is associated with the payment account, wherein the payment exception record is associated with the payment account;
determining a status of the payment exception record;
associating the status of the payment exception record with the image file;
designating a physical destination of the particular one of the plurality of payment instruments, wherein the physical destination is designated based on the status of the payment exception record; and
physically directing the particular one of the plurality of payment instruments to the designated destination.

11. The method of claim 10, further comprising generating a written communication, the generated written communication based on at least the status of the payment exception record.

12. The method of claim 10, further comprising:
assigning a unique identifier to the particular one of the plurality of payment instruments, the unique identifier associated with the generated written communication; and
initiating the printing of the unique identifier onto the particular one of the plurality of payment instruments.

13. The method of claim 10, wherein processing the plurality of payment instruments comprises:
generating the image file by scanning the particular one of the plurality of payment instruments; and
extracting payment information from the particular one of the plurality of payment instruments.

14. The method of claim 13, wherein the extracted payment information comprises the identifier for the account.

15. The method of claim 13, wherein the extracted payment information comprises the monetary value of the particular one of the plurality of payment instruments.

16. The method of claim 13, wherein the payment information is encoded in a magnetic ink character recognition format.

17. The method of claim 10, wherein the particular one of the plurality of payment instruments is a selected one of a group of payment instrument types, the group consisting of:
a) personal check;
b) certified check; and
c) cashier's check.

18. The method of claim 10, wherein associating the status of the payment exception record with the image file comprises updating an image file with information from a corresponding payment exception record for a given payment account.

19. A non-transitory computer readable medium comprising logic, when executed by a processor operable to:
process a plurality of payment instruments;
store an image file associated with a particular one of the plurality of payment instruments, the particular one of the plurality of payment instruments is associated with a payment account;
store a plurality of flagged account records, wherein each one of the flagged account records comprises a flagged account identifier for a flagged account;
determine if at least one flagged account record exists that is associated with the payment account;
create a payment exception record if at least one flagged account record exists that is associated with the payment account, wherein the payment exception record is associated with the payment account;
determine a status of the payment exception record;
associate the status of the payment exception record with the image file;
designate a physical destination of the particular one of the plurality of payment instruments, wherein the physical destination is designated based on the status of the payment exception record; and
initiate the physical directing of the particular one of the plurality of payment instruments to the designated destination.

20. The computer readable medium of claim 19, wherein the logic is further operable to generate a written communication, the generated written communication based on at least the status of the payment exception record.

21. The computer readable medium of claim 20, wherein the logic is further operable to:
assign a unique identifier to the particular one of the plurality of payment instruments, the unique identifier associated with the generated written communication; and
initiate the printing of the unique identifier onto the particular one of the plurality of payment instruments.

22. The computer readable medium of claim 19, wherein processing the plurality of payment instruments comprises:
generating the image file by scanning the particular one of the plurality of payment instruments; and
extracting payment information from the particular one of the plurality of payment instruments.

23. The computer readable medium of claim 22, wherein the extracted payment information comprises the identifier for the account.

24. The computer readable medium of claim 22, wherein the extracted payment information comprises the monetary value of the particular one of the plurality of payment instruments.

25. The computer readable medium of claim 22, wherein the payment information is encoded in a magnetic ink character recognition format.

26. The system of claim 19, wherein the particular one of the plurality of payment instruments is a selected one of a group of payment instrument types, the group consisting of:
a) personal check;
b) certified check; and
c) cashier's check.

27. The computer readable medium of claim 19, wherein associating the status of the payment exception record with the image file comprises updating an image file with information from a corresponding payment exception record for a given payment account.
